(19) United States
(12) Patent Application Publication
(10) Pub. No.: US 2006/0146743 A1
(43) Pub. Date: Jul. 6, 2006

(54) System and method for expedited communications between mobile stations

(76) Inventors: Ronald T. Crocker, St. Charles, IL (US); Rajeev Agrawal, Northbrook, IL (US); Thomas B. Hart, West Dundee, IL (US); Suresh Kalyanasundaram, Bangalore (IN); Jeffrey C. Smolinske, Schaumburg, IL (US); Stephen L. Spear, Skokie, IL (US)

Correspondence Address: MOTOROLA, INC., 1303 EAST ALGONQUIN ROAD, IL01/3RD, SCHAUMBURG, IL, 60196, US

(21) Appl. No.: 11/026,704

(22) Filed: Dec. 30, 2004

(51) Int. Cl. H04Q 7/00

(52) U.S. Cl. 370/328

(57) ABSTRACT

Communications are established between an originating mobile station (104) and a target mobile station (120) in an expedited manner. An initial short packet is transmitted from an originating mobile station (104) and the initial short packet is translated into an Internet Protocol (IP) packet. The IP packet is transmitted to a target Packet Control Unit (PCU) (116). An acknowledgment IP packet is responsively received from the target mobile station (120) via the target PCU (116) and a communication link is established between the originating mobile station (104) and the target mobile station (120).

### FIELD OF THE INVENTION

The field of the invention relates to the routing of communications through networks and, more specifically, to providing for expedited communications between mobile stations in networks.

### BACKGROUND OF THE INVENTION

In communication systems, mobile stations communicate with each other across one or more networks. In order to communicate, several functions are typically performed. For example, when an originating mobile station desires to communicate with a target mobile station, the target mobile station typically must be located. Once the target mobile station is located, the call itself must be set up and a channel established between the originating mobile station and the target mobile station.

Two known types of communication systems that link mobile stations together include the Global System for Mobile Communications (GSM) and General Packet Radio Service (GPRS). In these different systems, various elements facilitate the setup and establishment of communications between mobile stations. For example, GPRS networks often use Packet Control Units (PCUs) to help establish and maintain communication between mobile stations.

In known GPRS systems, call establishment procedures are used that necessitate the transmission of large IP packets. Because of the large packet size, the setup time may be several seconds (or more) between the time a push-to-talk (PTT) button is actuated at the originating mobile station and the user hears the voice of the target user at the target mobile station. The setup delay is also lengthened because the transmitting mobile station needs to be located. This long setup delay time can result in an excessive waiting period for users, the possibility of calls being dropped, and an unpleasant user experience as the user waits for the call to proceed.

### BRIEF DESCRIPTION OF THE DRAWINGS

FIG. 1 is a block diagram of a system for expediting communications between mobile stations according to the present invention;

FIG. 2 is a call flow diagram showing the expedited routing of information between mobile stations according to the present invention; and

FIG. 3 is a block diagram of a Packet Control Unit (PCU) according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF EMBODIMENTS

A system and method for expediting communications between an originating mobile station and a target mobile station uses an initial short packet when initiating the setup process and thereby shrink the time needed to establish a communication link with a target mobile station. The use of the initial short packet allows call setup to occur quickly and efficiently, and allows for some traditional messaging sequences (e.g., paging the target mobile station) to be avoided.

In many of these embodiments, communications are established in an expedited manner between an originating mobile station and a target mobile station. An originating PCU receives an initial short packet from the originating mobile station and translates the initial short packet into an Internet Protocol (IP) packet. The IP packet is transmitted to a target PCU. The target PCU translates the IP packet into a second short packet and sends the second short packet to the target mobile station. An acknowledgement of this second short packet is received by the target PCU from the target mobile station, and the target PCU translates this acknowledgement into a corresponding response IP packet and sends it to a server or other device (in the infrastructure) or to the originating mobile. Concurrent with the translation procedures occurring at both the originating and terminating PCU, a communication link is established between the originating mobile station and the target mobile station.

In others of these embodiments, a PCU is provided that expedites the establishment of a communication link between an originating mobile station and a target mobile station. The PCU includes a receiver that receives an initial short packet from an originating mobile station. The PCU also includes a transmitter. A controller is communicatively coupled to the receiver and the transmitter. The controller is programmed to receive the initial short packet from the originating mobile station and to translate the initial short packet into an IP packet. The controller is further programmed to transmit the IP packet to a target PCU via the transmitter. The controller is also programmed to receive an acknowledgment IP packet from the target mobile station and to establish a communication link between the originating mobile station and the target mobile station.

Thus, an expedited approach is provided to allow for an originating mobile station to establish a communication link with a target mobile station. The approaches described herein result in substantial time savings as compared to known approaches. Communication links are established quickly between an originating mobile station and a target mobile station. Since the link is established quickly, a user's experience is enhanced since there is little or no waiting required to effect a communication link with the user at the target mobile station.

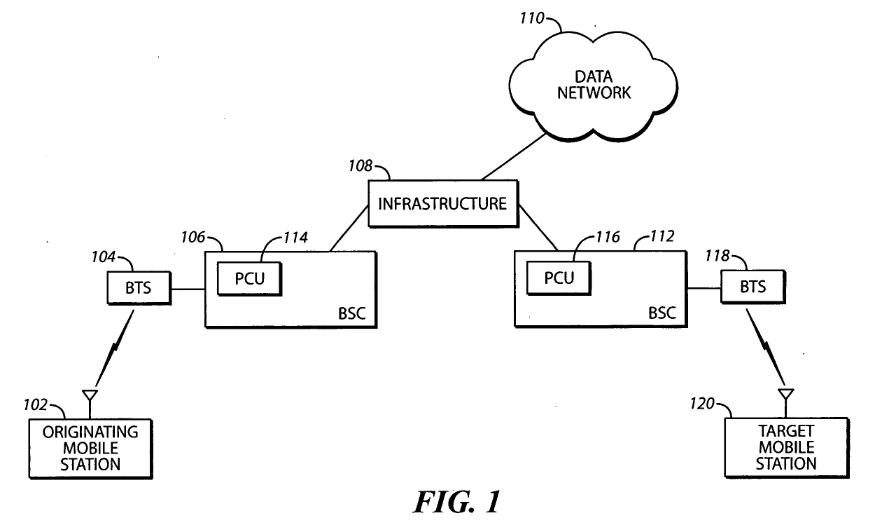

Referring now to FIG. 1, one example of a system for expediting communications between an originating mobile station and a target mobile station is described. The system includes an originating mobile station 102 and a target mobile station 120. The mobile stations 102 and 120 communicate with each other via a base transceiver station (BTS) 104, a first base station controller 106 (that includes a packet control unit 114), a telecommunication infrastructure 108, a second base station controller 112 (including a second PCU 116), and a BTS 118. The infrastructure 108 is also communicatively coupled to a data network 110. The data network 110 may be any type of network that is used to transmit data packets. For example, the data network 110 may be the Internet or an intranet. Other examples of data networks are possible.

The BTSs 104 and 118 provide an interface between mobile stations and other components of the system. For instance, the BTSs 104 and 118 may include a base station having receivers and transmitters that receive signals from and transmit signals to mobile stations.

The BSCs 106 and 112 include PCUs 114 and 116 respectively. The PCUs 114 and 116 translate packets from the format received from the BTSs 104 and 118 into IP packets, which can be transmitted by the infrastructure 108.

The infrastructure 108 includes various elements that are used to switch and move information from one destination to another. Specifically, and by way of example, the infrastructure 108 may include a mobile services switching center (MSC). The MSC may perform some of the switching functions in the infrastructure 108. In addition, the infrastructure 108 may include home location registers. The purpose of the home location registers is to permanently store information about subscribers, their location, and their activity status. Furthermore, the infrastructure 108 may also include visitor location registers. The purpose of the visitor location registers is to maintain temporary information about subscribers that is needed by the mobile services switching center (MSC) in order to service visiting subscribers.

Further, the infrastructure 108 may include Serving GPRS Support Nodes (SGSNs). The purpose of the SGSNs is to keep track of the location of mobile stations and perform security and access control functions. The infrastructure 108 may also include servers that route communications between different infrastructure components. Other types of elements may also be included in the infrastructure 108 depending upon the type of network or protocols used.

In one example of the operation of the system of FIG. 1, communications between the originating mobile station 102 and the target mobile station 120 are established and expedited by the use of an initial short packet. The initial short packet is created at the originating mobile station 102 and sent to the BTS. 104. The initial short packet may be created, for example, by a user pushing a PTT button at the originating mobile station 102 when the user desires to establish a communication link with the target mobile station 120. The initial short packet may, in one example, be 20 ms long. This is considerably shorter than long packets such as conventional SIP INVITE messages. In addition, although the embodiments described herein are in terms of PTT applications, it will be understood that other applications can be implemented, such as voice over Internet Protocol (VoIP) applications.

The BTS 104 includes components that receive the radio signal from the mobile station 102. The BTS 104 sends the received radio signal to the BSC 106, which includes the PCU 114. The initial short packet may include a bit that indicates to the PCU 114 that the PCU 114 must perform the translation and routing functions described herein. The PCU 114 receives the initial short packet and translates the initial short packet into an IP packet, for instance, an uplink channel request packet. Alternatively, the initial short packet may be transformed into some other format for transmission across the infrastructure 108.

The IP packet is transmitted to the second PCU 116, which resides at the second BSC 112. As mentioned, the IP packet is communicated via the telecommunication infrastructure 108. The IP packet is received at the second PCU 116, and an initialization request message is formed at the PCU 116. As with the initial short packet, the initialization request message is also a short message. For example, the initialization request message may be a downlink initialization message. The initialization request message is transmitted from the PCU 116 to the target mobile station 120. The target mobile station 120 receives the initialization request message and responsively forms an acknowledgement message. The acknowledgement message, for example, an uplink data transfer message, is sent from the target mobile station 120 to the BTS 118 and then to the second PCU 116. The second PCU 116 translates the message into an IP packet and transmits the acknowledgement packet over the telecommunication infrastructure 108 to the first PCU 114.

The first PCU 114 translates the acknowledgement packet into a non-IP acknowledgement packet, for example, a downlink transfer message, and sends this message to the BTS 104 for transmission to the originating mobile station 102. Alternatively, the IP packet may be sent directly to the mobile station 102. Upon receipt, the mobile station 102 may play a talk permit tone (TPN) to the user. Concurrent with the translations and other processing described above, a communication link is established between the originating mobile station 102 and the target mobile station 120.

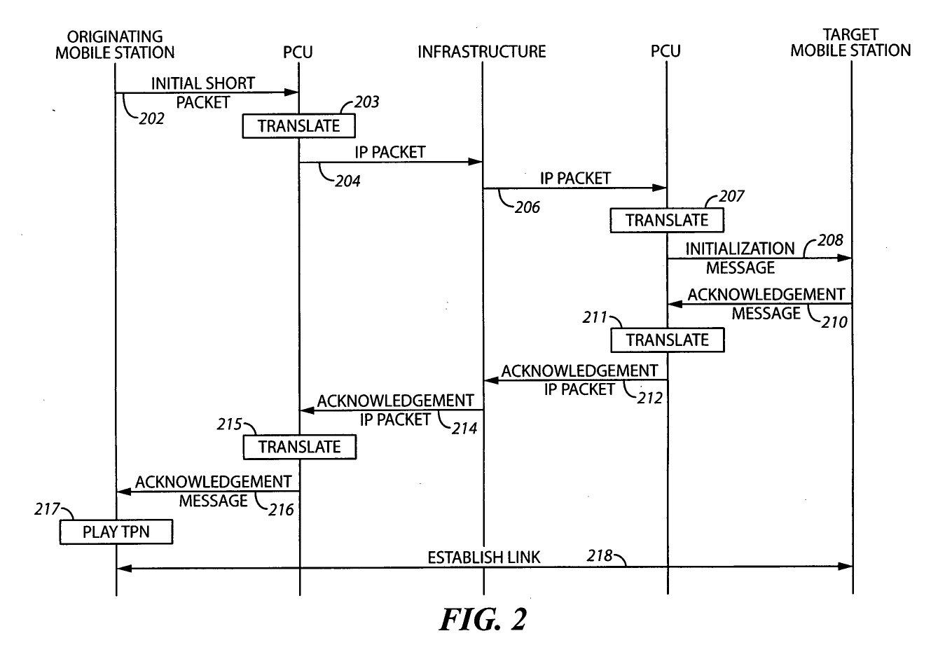

Referring now to FIG. 2, one example of an approach for expediting communications between an originating mobile station and a target mobile station is described. This approach results in the quick and easy establishment of a communication link between an originating mobile station and a target mobile station.

At step 202, an initial short packet is sent from the originating mobile station to the first PCU. The initial short packet may be an uplink channel request message and may include a bit that the PCU examines so that the PCU performs the following steps. The initial short packet is formed by some user action at the originating mobile station, for instance, the user pressing a PTT button at the originating mobile station. At step 203, the packet is translated into an IP packet. At step 204, the IP packet is transmitted across the infrastructure. During this step, the IP packet is sent across various servers and other infrastructure components to reach a second PCU that services the target mobile station. This step may also include the sending of multiple IP packets rather than a single packet.

At step 206, the IP packet is received at the second PCU. At step 207, the IP packet is translated to an initialization request message (a non-IP packet), for example, a downlink media assignment message as used in GPRS systems. This message is also a short message.

At step 208, the initialization request message is transmitted to the target mobile station. A Radio Access Network (RAN) may be used to perform this function. At step 210, the target mobile station returns an acknowledgement message, for example, an uplink transfer message, to the second PCU. This may also be accomplished by using the RAN. At step 211, the second PCU translates the acknowledgement message into an IP packet. At step 212, the IP acknowledgement packet is sent to a server or some other device in the infrastructure.

At step 214, the acknowledgement IP packet is transmitted from the infrastructure to the first PCU. At step 215, the packet is translated into a non-IP acknowledgement message, for instance a downlink transfer message. As mentioned above, the IP acknowledgement packet may also be sent to the originating mobile station without translation. At step 216, the downlink transfer message is sent from the first PCU to the originating mobile station. At step 217, a TPN is played for the user at the originating mobile station. At step 218, a communication link is established between the originating mobile station and the target mobile station. This step may be performed concurrently with some or all of the steps performed above.

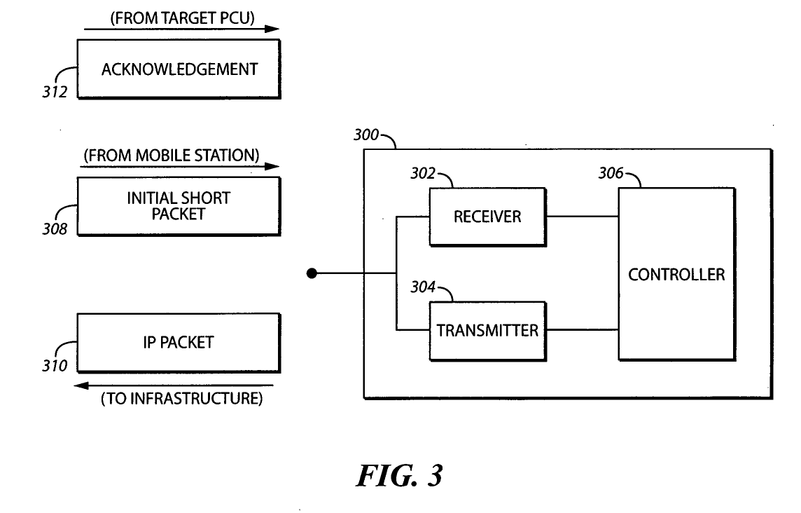

Referring now to FIG. 3, one example of a Packet Control Unit (PCU) 300 is described. The PCU 300 includes a receiver 302, a transmitter 304, and a controller 306. The receiver 302 and transmitter 304 are connected to other elements of the network, for example, the network infrastructure (which communicates with other PCUs) and base station controllers (BSCs) (through which mobile stations are accessed).

The receiver 302 has an input for receiving an initial short packet 308 from an originating mobile station. The controller 306 is programmed to receive the initial short packet 308 from the originating mobile station at the input of the receiver 302 and to translate the initial short packet into an IP packet 310. The controller 306 is further programmed to transmit the IP packet 310 to a target PCU at the output of the transmitter 304. The controller 306 is additionally programmed to receive, at the input of the receiver 302, an acknowledgment IP packet 312 from the target mobile station. The controller 306 translates the acknowledgement into a non-IP message, for example, a downlink transfer message, to be sent to the originating mobile station. A communication link is established between the originating mobile station and the target mobile station concurrently with the translation process.

Thus, an expedited approach is provided to allow for an originating mobile station to establish a communication link with a target mobile station. Communication links between origination and target-mobile stations are quickly and efficiently established. Time savings are realized since traditional message sequences including, for example, paging a target mobile station, are reduced or eliminated.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

1. A method of establishing and expediting communications between an originating mobile station and a target mobile station comprising
receiving an initial short packet from an originating mobile s ton and translating the initial short packet into an initial Internet Protocol (IP) packet based at least in part on the contents of the initial short packet; and
transmitting the initial IP packet to the target mobile station.

2. The method of claim 1 wherein receiving the initial short packet comprises receiving an uplink channel request message.

3. The method of claim 1 wherein transmitting the initial IP packet comprises transmitting the initial IP packet to the target PCU via at telecommunication infrastructure.

4. The method of claim 1 further comprising translating the initial IP packet to a second short packet at the target PCU.

5. The method of claim 1 further comprising actuating a push-to-talk (PTT) button and responsively creating the initial short packet.

6. A method of establishing and expediting communications between an originating mobile station and a target mobile station comprising:
receiving an initial IP packet at a target PCU and responsively translating the initial IP packet at the target PCU into a short packet;
transmitting the short packet to the target mobile station;
receiving an acknowledgement from the target mobile station; and
responsive to receiving the acknowledgement from the target mobile station, generating a response IP packet based at least in part upon the contents of the initial IP packet, sending the response IP packet to the originating mobile station, and establishing a communication link between the originating mobile station and the target mobile station.

7. The method of claim 6 further comprising sending the IP packet to the target PCU from and originating PCU.

8. The method of claim 6 wherein receiving the acknowledgement comprises receiving an uplink data transfer message.

9. The method of claim 6 wherein receiving the IP packet comprises receiving the IP packet at the second PCU via a telecommunication infrastructure.

10. The method of claim 6 wherein receiving the acknowledgement comprises receiving an uplink data transfer message.

11. A Packet Control Unit (PCU) comprising:
a receiver having an input for receiving an initial short packet from an originating mobile station;
a transmitter having an output; and
a controller communicatively coupled to the receiver and the transmitter, the controller programmed to receive the initial short packet from the originating mobile station at the input of the receiver and to translate the initial short packet into an IP packet, the controller further programmed to transmit the IP packet to a target PCU at the output of the transmitter, the controller further programmed to receive at the input of the receiver a acknowledgment IP packet from the target mobile station and to subsequently establish a communication link between the originating mobile station and the target mobile station.

12. The PCU of claim 11 wherein the initial short packet is produced at the originating mobile station by actuating a pushing a push-to-talk (PIT) button.

13. The PCU of claim 11 wherein the transmitter is communicatively coupled to a telecommunication infrastructure and the IP packet is transmitted to the target PCU via the telecommunication infrastructure.

14. The PCU of claim 11 wherein the initial short packet is an uplink channel request message.

15. The PCU of claim 11 wherein the acknowledgement message is an uplink data transfer message.

16. The method of claim 1 wherein translating the initial short packet into the initial IP packet comprises translating the initial short packet into an initial IP packet that comprises SIP messaging.

17. The method of claim 1 wherein the initial short packet comprises an indication that the initial short packet should be translated

18. The PCU of claim 11 wherein the initial short packet comprises SIP messaging.

19. The PCU of claim 11 wherein the initial short packet comprises an indication that the initial short packet should be translated.
